(19) United States
(12) Patent Application Publication
(10) Pub. No.: US 2015/0059183 A1
(43) Pub. Date: Mar. 5, 2015

(54) METHOD OF REMOVING A BEARING FROM A SHAFT

(71) Applicant: General Electric Company, Schenectady, NY (US)

(72) Inventor: Ulrich Werner Neumann, Simpsonville, SC (US)

(73) Assignee: General Electric Company, Schenectady, NY (US)

(21) Appl. No.: 14/018,717

(22) Filed: Sep. 5, 2013

(51) Int. Cl. B23P 15/00

(52) U.S. Cl. CPC B23P 15/003
USPC 29/898.08

(57) ABSTRACT

A method of removing a part from a shaft is provided. The part is attached to the shaft with an interference fit. The method includes the steps of, inserting an expandable plug into the shaft, and adding coolant to an interior of the shaft. The coolant cools the shaft from the interior of the shaft to an exterior of the shaft. Another step removes the part from the shaft. The part is removed from the shaft without sustaining damage to either the part or the shaft, so that the part and the shaft may be refurbished or reused.

### BACKGROUND OF THE INVENTION

The method described herein relates generally to bearing removal. More specifically, the method relates to cooling a shaft from the inside to remove a bearing, without causing damage to the bearing.

In a typical wind turbine gearbox repair, bearings are removed from shafts by heating the inner race of the bearing rapidly with a torch (e.g., an oxy-acethylene type torch). Bearings are often attached to shafts by an interference fit or heat shrink fit. The heating expands the inner race and temporarily turns the interference fit into a loose fit, thus allowing the removal of the bearing. This is common practice and was previously acceptable since the bearings were not being reused but simply scrapped and replaced by new ones. Many modern wind turbines have parts that can be refurbished and reused, so disposing of potentially reusable parts is wasteful and economically disadvantageous.

The use of any type of fuel gas torch device precludes the removed bearings from being reused since their metal's grain structure will most likely have been negatively affected. A bearing, such as a main shaft bearing in a wind turbine, is an expensive and robustly made part that could be reconditioned by the original equipment manufacturer (OEM) or a qualified shop for a fraction of the cost of a new part. Applying the commonly used removal processes as described above renders an otherwise perfectly good core useless. Furthermore, applying intense heat to localized areas will never achieve a uniform distribution and may make the use of a large bearing pulling device necessary. This approach harbors the risk of rolling a burr and scoring the softer surface of the shaft which now would have to be reconditioned as well. The currently known methods of removing a bearing from a shaft result in damage to, and the disposal of, the bearing and possibly the shaft.

### BRIEF DESCRIPTION OF THE INVENTION

In an aspect of the present invention, a method of removing a part from a shaft is provided. The part is attached to the shaft with an interference fit. The method includes the steps of, inserting an expandable plug into the shaft, and adding coolant to an interior of the shaft. The coolant cools the shaft from the interior of the shaft to an exterior of the shaft. Another step removes the part from the shaft. The part is removed from the shaft without sustaining damage to either the part or the shaft, so that the part and the shaft may be refurbished or reused.

In another aspect of the present invention, a method of removing a bearing from a main shaft is provided. The bearing is attached to the main shaft with an interference fit, and both the bearing and main shaft are parts of a wind turbine. The method includes the steps of, inserting an expandable plug into the main shaft, and adding coolant to an interior of the main shaft. The coolant cools the main shaft from the interior of the main shaft to an exterior of the main shaft. A removing step removes the bearing from the main shaft. The bearing is removed from the main shaft by transforming the interference fit into a loose fit, and without sustaining damage to either the bearing or the main shaft, so that the bearing and the main shaft may be refurbished or reused.

In yet another aspect of the present invention, a method of removing a bearing from a main shaft is provided. The bearing is attached to the main shaft with an interference fit, and both the bearing and main shaft are parts of a wind turbine. The method includes the steps of, orienting the bearing and the main shaft substantially vertically, inserting an expandable plug into the main shaft, and adding coolant to an interior of the main shaft. The coolant cools the main shaft from the interior of the main shaft to an exterior of the shaft. Another step is used for removing the bearing from the main shaft. The bearing is removed from the main shaft by transforming the interference fit into a loose fit, and without sustaining damage to either the bearing or the main shaft, so that the bearing and the main shaft may be (or are) refurbished and/or reused. Additional steps may include monitoring a level of the coolant and adding additional coolant if the level of the coolant drops more than a predetermined amount, monitoring a temperature of the main shaft, or applying heat to the bearing, where the heat is applied at a level to avoid damage to the bearing. The coolant is at least one of liquid nitrogen, dry ice/acetone, dry ice/isopropanol alcohol, butyl acetate/dry ice, propyl amine/dry ice, ethyl ether/dry ice, ethyl acetate/LN2, n-butanol/LN2, hexane/LN2, acetone/LN2, toluene/LN2, or methanol/LN2.

### BRIEF DESCRIPTION OF THE DRAWINGS

FIG. 1 is a perspective illustration of an exemplary wind turbine;

FIG. 2 is a partially cut-away perspective illustration of a portion of the wind turbine shown in FIG. 1;

FIG. 3 illustrates a main shaft bearing mounted on the main shaft;

FIG. 4 illustrates a main shaft bearing and main shaft positioned for a removal method, according to an aspect of the present invention; and

FIG. 5 illustrates a flowchart for a method for removing a bearing from a shaft, according to an aspect of the present invention.

### DETAILED DESCRIPTION OF THE INVENTION

One or more specific aspects/embodiments of the present invention will be described below. In an effort to provide a concise description of these aspects/embodiments, all features of an actual implementation may not be described in the specification. It should be appreciated that in the development of any such actual implementation, as in any engineering or design project, numerous implementation-specific decisions must be made to achieve the developers' specific goals, such as compliance with machine-related, system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “one aspect” or “an embodiment” or “an aspect” of the present invention are not intended to be interpreted as excluding the existence of additional embodiments or aspects that also incorporate the recited features.

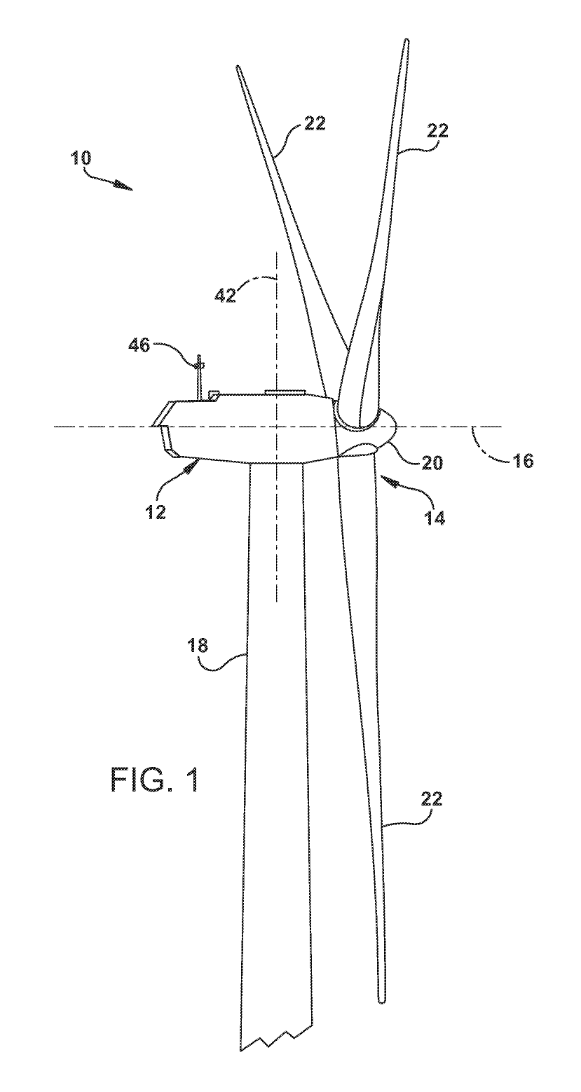

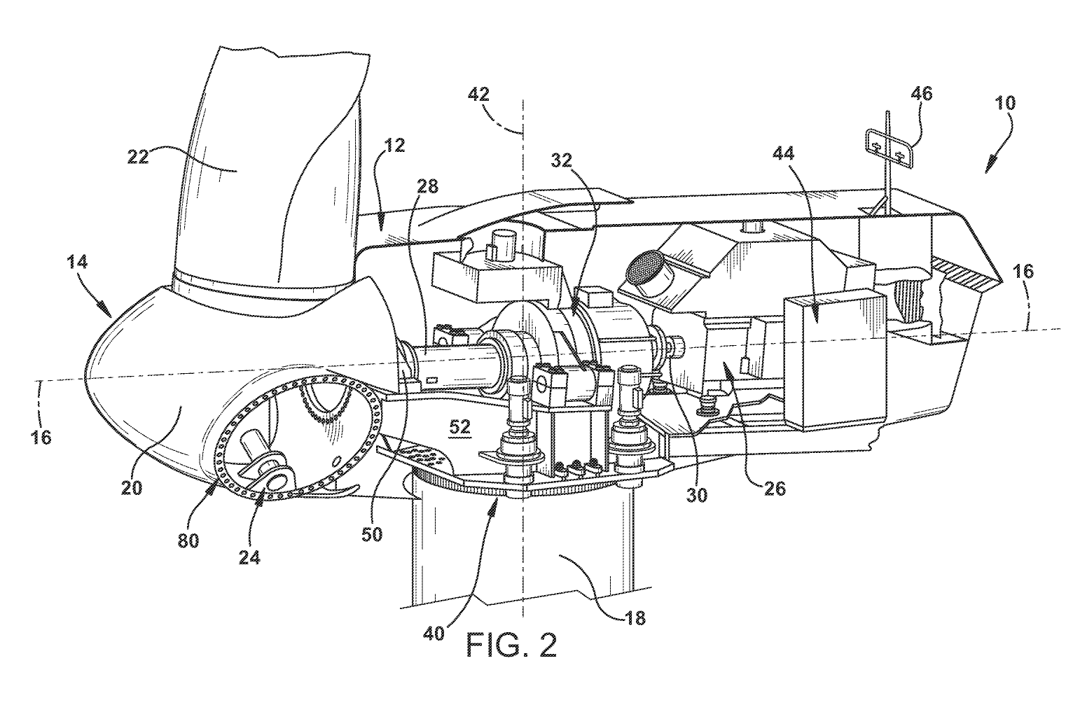

FIG. 1 is a perspective view of an exemplary wind turbine 10. Wind turbine 10 described and illustrated herein is a wind generator for generating electrical power from wind energy. Wind turbine 10 described and illustrated herein includes a horizontal-axis configuration. In some known wind turbines, wind turbine 10 includes a vertical-axis configuration (not shown). Wind turbine 10 may be coupled to an electrical load (not shown), such as, but not limited to, a power grid (not shown), and may receive electrical power therefrom to drive operation of wind turbine 10 and/or its associated components and/or may supply electrical power generated by wind turbine 10. Although only one wind turbine 10 is shown in FIGS. 1-2, in some embodiments a plurality of wind turbines 10 are grouped together, to form a “wind farm”.

Wind turbine 10 includes a nacelle 12, and a rotor (generally designated by 14) coupled to body 12 for rotation with respect to body 12 about an axis of rotation 16. In the exemplary embodiment, nacelle 12 is mounted on a tower 18. The height of tower 18 is any suitable height enabling wind turbine 10 to function as described herein. Rotor 14 includes a hub 20 and a plurality of blades 22 (sometimes referred to as “airfoils”) extending radially outwardly from hub 20 for converting wind energy into rotational energy. Although rotor 14 is described and illustrated herein as having three blades 22, rotor 14 may include any number of blades 22. The blades are mounted to a hub flange 80 and each blade is pitched by pitch motor 24.

FIG. 2 is a partially cut-away perspective view of a portion of the exemplary wind turbine 10. Wind turbine 10 includes an electrical generator 26 coupled to rotor 14 for generating electrical power from the rotational energy generated by rotor 14. Generator 26 is any suitable type of electrical generator, such as, but not limited to, a wound rotor induction or permanent magnet generator. Rotor 14 includes a low speed rotor shaft 28 (or main shaft) coupled to rotor hub 20 for rotation therewith. The main shaft 28 is typically supported by one or more main shaft bearings 50. The bearing are mounted to bedplate 52. Generator 26 is coupled to a high speed rotor shaft 30 such that rotation of rotor shaft 28 drives rotation of the generator rotor, and therefore operation of generator 26. In the exemplary embodiment, high speed rotor shaft 30 is coupled to low speed shaft 28 through a gearbox 32, although in other embodiments generator rotor shaft 30 is coupled directly to rotor shaft 28. The rotation of rotor 14 drives the generator rotor to thereby generate variable frequency AC electrical power from rotation of rotor 14.

In some embodiments, wind turbine 10 includes a brake system (not shown) for braking rotation of rotor 14. Furthermore, in some embodiments, wind turbine 10 includes a yaw system 40 for rotating nacelle 12 about an axis of rotation 42 to change a yaw of rotor 14. Yaw system 40 is coupled to and controlled by a control system(s) 44. In some embodiments, wind turbine 10 includes anemometry 46 for measuring wind speed and/or wind direction. Anemometry 46 is coupled to control system(s) 44 for sending measurements to control system(s) 44 for processing thereof. In the exemplary embodiment, control system(s) 44 is mounted within nacelle 12. Alternatively, one or more control systems 44 may be remote from nacelle 12 and/or other components of wind turbine 10. Control system(s) 44 may be used for, but is not limited to, overall system monitoring and control including, for example, pitch and speed regulation, high-speed shaft and yaw brake application, yaw and pump motor application, and/or fault monitoring. Alternative distributed or centralized control architectures may be used in some embodiments.

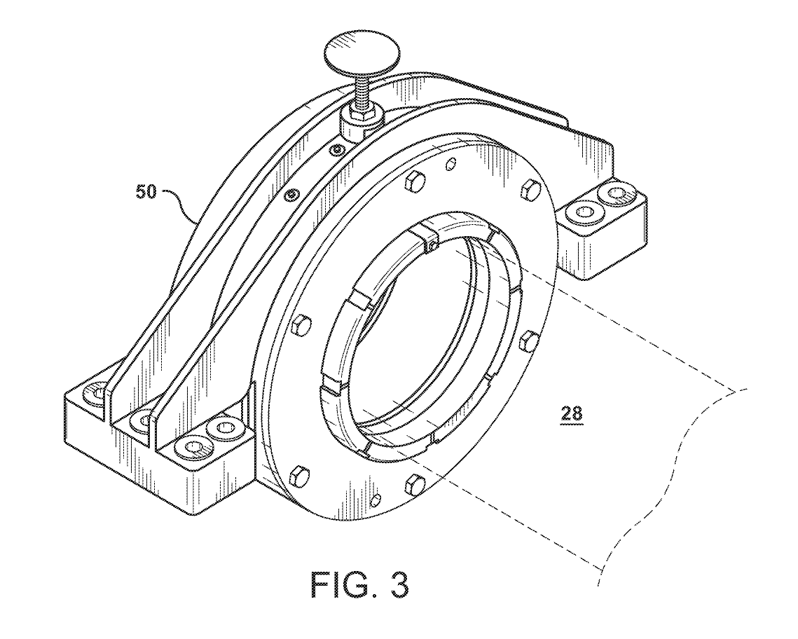

FIG. 3 illustrates a main shaft bearing 50 mounted on the main shaft 28 (shown in phantom). As mentioned previously, the main shaft bearing 50 is attached to the main shaft 28 with an interference fit. The bearing 50 is a robustly made part and it can be refurbished and reused. However, heating of the bearing 50 may adversely affect the metal's grain structure, and the heat removal method turns a reusable part into a scrap part.

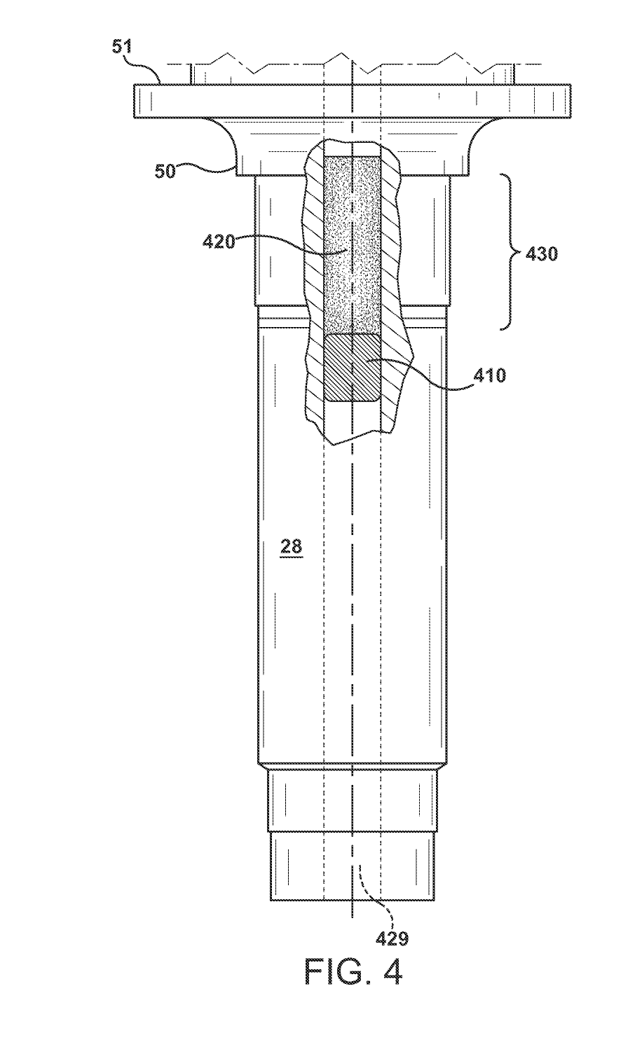

FIG. 4 illustrates a main shaft bearing 50 and main shaft 28 positioned for a removal method, according to an aspect of the present invention. The main shaft 28 may be positioned up-right and suspended in a rack (not shown) to prevent it from tipping over. The large flange 51 is facing upwards. An expandable plug 410 is inserted into the through hole 429 of the main shaft 28 and positioned at a depth corresponding to the position of the bearing seat on the outside of the main-shaft 28. The expandable plug 410 may be comprised of any suitable polymeric material, natural or synthetic material, or any other suitable insulating and expandable material. The expandable plug 410 can be inserted in a non-expanded state, and then inflated to seal the through hole 429.

The area of the main shaft 28 to be cooled is indicated by numeral 430. The upper part of the through hole 429 may then be filled with a coolant 420, such as liquid Nitrogen (LN₂). The evaporating coolant 420 withdraws heat from the main shaft 28 from the inside out, thus causing it to shrink. A steady trickle of coolant 420 into the through hole 429 will keep the coolant level nearly to the top thereby maximizing the cooling effect. During the cooling process, the surface temperature of the main shaft 28 may be monitored. If a noticeable temperature drop has occurred, mild force onto the main bearing 50 housing in the downwards direction may be applied. Optionally, a heating blanket (not shown) may placed on or around the bearing 50 to keep the bearing 50 from cooling down as well, which would negate the cooling efforts. Once the proper heat differential has been reached, the bearing 50 will drop off the main shaft 28.

The coolant 420 may be LN₂ and this coolant is sufficient to cool the main shaft in region 430. However, LN₂ may suffer from the Leidenfrost effect, which is a phenomenon where liquid, in contact with a surface significantly hotter than the liquid's boiling point, produces an insulating vapor layer, that keeps the liquid from boiling rapidly. The Leidenfrost effect, when experienced by LN₂, may extend the exposure time needed to obtain a desired temperature differential between the main shaft 28 in region 430 and the bearing 50. Other coolants that may be less susceptible to the Leidenfrost effect may include mixes of dry ice (solid CO₂) and acetone or isopropanol alcohol. These mixes remain fluid during the cooling process and the fluid increases the heat transfer (or cooling) rate. Additional coolant mixes may also include butyl acetate/dry ice, propyl amine/dry ice, ethyl ether/dry ice, ethyl acetate/LN₂, n-butanol/LN₂, hexane/LN₂, acetone/LN₂, toluene/LN₂, and methanol/LN₂, or any other suitable coolant mixture.

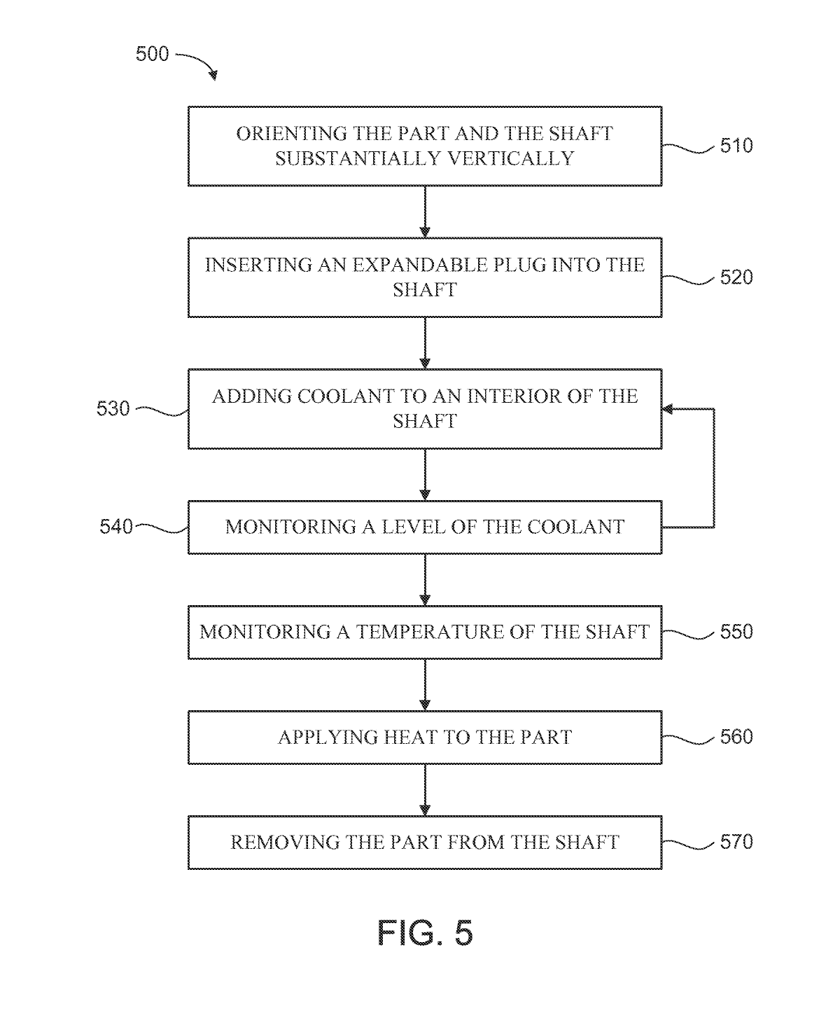

FIG. 5 illustrates a flowchart for a method 500 for removing a bearing 50 (or a part) from a shaft 28, according to an aspect of the present invention. The method 500 includes the steps of orienting (step 510) the part 50 and the shaft 28 substantially vertically. The shaft could be oriented in non-vertical directions, as long as the coolant 420 can be kept in the target region 430 within shaft 28. Step 520 inserts an expandable plug 410 into the shaft 28, and preferably into through hole 429. The expandable plug 410 may be located at one end of region 430. Step 530 adds coolant 420 to an interior of shaft 28, and preferably into the through hole 429. As mentioned previously, the coolant may be liquid nitrogen, dry ice/acetone, dry ice/isopropanol alcohol, or any other suitable coolant. The expandable plug 410 prevents the coolant from leaking past the expandable plug 410. The coolant 420 cools the shaft 28, specifically in region 430, from the inside out (i.e., from the interior of the shaft 28 to the exterior or surface of shaft 28).

Step 540 monitors the level of the coolant 420, as the coolant will evaporate over time. When too much of the coolant 420 evaporates or the coolant 420 level drops more than a predetermined amount, more coolant 420 can be added by repeating step 530. The temperature of the shaft 28 or bearing seat can be monitored in step 550. Optionally, the temperature of the bearing 50 may also be monitored. When a predetermined temperature differential between the shaft 28 and part 50 exists, the interference fit is changed to a loose fit, and the part 50 can be removed. Optionally, step 560 can be used to apply heat to the part or bearing 50. This heat may be applied with a heating blanket or other mild heat source. The important thing is to avoid applying too much heat, so that damage to the bearing 50 is avoided. A final step 570 removes the bearing 50 (or part) from the shaft 28, and this occurs when the interference fit has been transformed into a loose fit.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of removing a part from a shaft, the part attached to the shaft with an interference fit, the method comprising the steps of:
inserting an expandable plug into the shaft;
adding coolant to an interior of the shaft, the coolant cooling the shaft from the interior of the shaft to an exterior of the shaft;
removing the part from the shaft; and
wherein the part is removed from the shaft without sustaining damage to either the part or the shaft, so that the part and the shaft may be refurbished or reused.

2. The method of claim 1, further comprising:
orienting the part and the shaft substantially vertically.

3. The method of claim 1, further comprising:
monitoring a level of the coolant;
adding additional coolant if the level of the coolant drops more than a predetermined amount.

4. The method of claim 1, further comprising:
monitoring a temperature of the shaft.

5. The method of claim 1, further comprising:
applying heat to the part, the heat applied at a level to avoid damage to the part.

6. The method of claim 1, wherein the coolant is at least one of:
liquid nitrogen, dry ice/acetone, or dry ice/isopropanol alcohol.

7. The method of claim 1, wherein the coolant is at least one of:
liquid nitrogen, dry ice/acetone, dry ice/isopropanol alcohol, butyl acetate/dry ice, propyl amine/dry ice, ethyl ether/dry ice, ethyl acetate/LN₂, n-butanol/LN₂, hexane/LN₂, acetone/LN₂, toluene/LN₂, or methanol/LN₂.

8. The method of claim 1, wherein the part is a bearing and the shaft is a main shaft of a wind turbine.

9. A method of removing a bearing from a main shaft, the bearing attached to the main shaft with an interference fit, and both the bearing and main shaft comprising parts of a wind turbine, the method comprising the steps of:
inserting an expandable plug into the main shaft;
adding coolant to an interior of the main shaft, the coolant cooling the main shaft from the interior of the main shaft to an exterior of the main shaft;
removing the bearing from the main shaft; and
wherein the bearing is removed from the main shaft by transforming the interference fit into a loose fit, and without sustaining damage to either the bearing or the main shaft, so that the bearing and the main shaft may be refurbished or reused.

10. The method of claim 9, further comprising:
orienting the bearing and the main shaft substantially vertically.

11. The method of claim 10, further comprising:
monitoring a level of the coolant;
adding additional coolant if the level of the coolant drops more than a predetermined amount.

12. The method of claim 11, further comprising:
monitoring a temperature of the main shaft.

13. The method of claim 12, wherein the coolant is at least one of:
liquid nitrogen, dry ice/acetone, or dry ice/isopropanol alcohol.

14. The method of claim 12, wherein the coolant is at least one of:
liquid nitrogen, dry ice/acetone, dry ice/isopropanol alcohol, butyl acetate/dry ice, propyl amine/dry ice, ethyl ether/dry ice, ethyl acetate/LN₂, n-butanol/LN₂, hexane/LN₂, acetone/LN₂, toluene/LN₂, or methanol/LN₂.

15. The method of claim 13, further comprising:
applying heat to the bearing, the heat applied at a level to avoid damage to the bearing.

16. A method of removing a bearing from a main shaft, the bearing attached to the main shaft with an interference fit, and both the bearing and main shaft comprising parts of a wind turbine, the method comprising the steps of:
orienting the bearing and the main shaft substantially vertically;
inserting an expandable plug into the main shaft;
adding coolant to an interior of the main shaft, the coolant cooling the main shaft from the interior of the main shaft to an exterior of the shaft;
removing the bearing from the main shaft; and
wherein the bearing is removed from the main shaft by transforming the interference fit into a loose fit, and without sustaining damage to either the bearing or the main shaft, so that the bearing and the main shaft may be refurbished or reused.

17. The method of claim 16, further comprising:
monitoring a level of the coolant; and
adding additional coolant if the level of the coolant drops more than a predetermined amount.

18. The method of claim 16, further comprising:
monitoring a temperature of the main shaft.

19. The method of claim 16, wherein the coolant is at least one of:
liquid nitrogen, dry ice/acetone, dry ice/isopropanol alcohol, butyl acetate/dry ice, propyl amine/dry ice, ethyl ether/dry ice, ethyl acetate/LN₂, n-butanol/LN₂, hexane/LN₂, acetone/LN₂, toluene/LN₂, or methanol/LN₂.

20. The method of claim 16, further comprising:
applying heat to the bearing, the heat applied at a level to avoid damage to the bearing.
